(19) United States
(12) Patent Application Publication
(10) Pub. No.: US 2022/0405220 A1
(43) Pub. Date: Dec. 22, 2022

(54) INTERCONNECT LAYER SEND QUEUE RESERVATION SYSTEM

(71) Applicant: NetApp, Inc., San Jose, CA (US)

(72) Inventors: Ping Zhou, Morrisville, NC (US); Joseph Brown, JR., Raleigh, NC (US); Peter Brown, Raleigh, NC (US); Bipin Tomar, Morrisville, NC (US)

(21) Appl. No.: 17/502,397

(22) Filed: Oct. 15, 2021

Related U.S. Application Data
(60) Provisional application No. 63/211,671, filed on Jun. 17, 2021.

(51) Int. Cl. G06F 13/28; G06F 3/06

(52) U.S. Cl. CPC G06F 13/28; G06F 3/0613; G06F 3/0644; G06F 3/067; G06F 2213/28

(57) ABSTRACT

Systems and methods for an interconnect layer send queue reservation system are provided. In one example, a method involves performing a transfer of data (e.g., an NVLog) from a storage system to a secondary storage system. A send queue having a fixed number of slots is maintained within an interconnect layer interposed between a file system and a Remote Direct Memory Access (RDMA) layer of the storage system. The interconnect layer implements an application programming interface (API) for the reservation system. A deadlock situation is avoided by, during a suspendable phase of a write transaction, making a reservation for slots within the send queue via the reservation system for the transfer of data. When the reservation is successful, the write transaction proceeds with a modify phase, during which the reservation is consumed and the interconnect layer is caused to perform an RDMA operation to carry out the transfer of data.

### CROSS-REFERENCE TO RELATED PATENTS

This application claims the benefit of priority of U.S. Provisional Application No. 63/211,671, filed on Jun. 17, 2021, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright ©2021, NetApp, Inc.

### FIELD

Various embodiments of the present disclosure generally relate to data storage systems. In particular, some embodiments relate to a priority-based approach for managing reservations of slots within an interconnect layer send queue for performing Remote Direct Memory Access (RDMA) write operations from one network storage system to another, for example, in connection with storage operation journal mirroring to support high-availability (HA) and/or disaster recovery (DR).

### BACKGROUND

A data backup technique referred to as “mirroring” involves backing up data stored at one network storage system (e.g., a source or primary storage node) by storing an exact duplicate (a mirror image) of the data at another network storage system (e.g., a destination or secondary storage node). Depending on the particular high availability (HA) or disaster recovery (DR) configuration within a clustered pair of network storage systems, for example, one may be designated as the primary and may be responsible for serving all storage requests (e.g., read and write requests) made by clients and the other may be designated as the secondary. In such a case, the mirroring is performed in one direction (e.g., from the primary to the secondary). Alternately, both network storage systems may be operable to serve storage requests, and both may be capable of operating in the role of a primary or secondary with respect to the other. In this configuration, the mirroring may be performed in either direction depending upon the network storage system that is operating as the source storage node for a particular storage request.

The source storage node receives and responds to various read and write requests from client devices. In the context of a storage solution that handles large volumes of client requests, it may be impractical to persist data modifications to mass storage devices connected to the storage nodes every time a write request is received from a client as disk accesses tend to take a relatively long time compared to other operations. Therefore, the source storage node may instead hold write requests in memory temporarily (e.g., in a buffer cache) and only periodically save the modified data to the mass storage devices, such as every few seconds. The event of saving the modified data to the mass storage devices may be referred to as a consistency point. At a consistency point, a source storage node saves any data that was modified by write requests to its local mass storage devices and triggers a process of updating the mirrored data stored at the destination storage node.

In this approach, there is a small risk of a system failure occurring between consistency points, causing the loss of data modified after the last consistency point. Consequently, in at least one approach, the storage nodes may maintain a log of certain storage operations within a non-volatile (NV) memory (e.g., a NV random access memory (NVRAM)) that have been performed since the last consistency point. For example, this log (which may be referred to as an NVLog) may include a separate journal entry for each storage request received from a client that results in a modification to the file system or data. Such entries for a given file may include, for example, “Create File,” “Write File Data,” “Open File,” and the like. Each NVLog entry may also include the data to be written according to the corresponding request. The NVLog may be used in the event of a failure to recover data that would otherwise be lost. For example, in the event of a failure, it may be possible to replay the NVLog to reconstruct the current state of stored data just prior to the failure. In one example, after each consistency point is completed, the NVLog is cleared and started anew.

To protect against a failure of the primary storage node (including its NVLog), an approach called clustered failover (CFO) may be used in which the primary and the secondary storage nodes operate as “cluster partners” and are connected via a HA interconnect link. In addition to the dataset mirroring described above, the metadata regarding the storage requests logged to the NVLog may also be mirrored to one or more cluster partners (e.g., HA and/or DR partner network storage systems). As mirroring of the log data from one network storage system to an HA and/or a DR partner network storage system via Remote Direct Memory access (RDMA) operations is performed responsive to carrying out the corresponding storage operations at the file system layer, various actions associated with the NVLog mirroring process may be triggered by one or more of multiple storage operation phases within the file system layer.

Some file systems (e.g., multi-phase file systems or write-anywhere file systems, such as the proprietary Write Anywhere File Layout (WAFL) Copy-on-Write file system available from NetApp, Inc. of San Jose, Calif.), perform multiple phases (e.g., load and modify) before data associated with a write operation is written to disk. For example, during the load phase for a write operation, file system data (e.g., Modes) may be loaded from disk into memory. Thereafter, lock (if applicable), modify, and resize (if applicable) phases may be performed in sequence.

### SUMMARY

Systems and methods are described for an interconnect layer send queue reservation system. According to one embodiment, a storage system includes one or more processing resources and one or more non-transitory computer-readable media, coupled to the one or more processing resources, having stored therein instructions that when executed by the one or more processing resources cause the storage system to perform a transfer of data from the storage system to another storage system. A send queue having a fixed number of slots is maintained within an interconnect layer interposed between a file system and a Remote Direct Memory Access (RDMA) layer of the storage system. During a first phase of a write transaction of the file system, the transfer of data is facilitated by making a reservation for slots within the send queue. Subsequently, during a second phase of the write transaction, the reservation is consumed and the interconnect layer is caused to perform an RDMA operation to carry out the transfer of data.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a high-level block diagram conceptually illustrating an environment in which various embodiments may be implemented.

FIG. 2 is a simplified block diagram conceptually illustrating interactions among various layers of a storage node in accordance with an embodiment of the present disclosure.

FIG. 3 is a flow diagram illustrating multi-phase message processing in accordance with an embodiment of the present disclosure.

FIG. 4 illustrates an example computer system in which or with which embodiments of the present disclosure may be utilized.

### DETAILED DESCRIPTION

Systems and methods are described for an interconnect layer send queue reservation system. As noted above, to support HA and/or DR in addition to dataset mirroring a log of certain storage transactions performed at a source network storage system may be maintained within a local NVLog and mirrored to respective remote NVLogs of one or more HA and/or DR partner network storage systems. As described further below, the operation log mirroring, which makes use of underlying RDMA operations, may involve the file system requesting an interconnect (IC) layer, logically interposed between the file system layer and the RDMA layer, to perform a write transaction to transfer all or some portion of the local NVLog (e.g., stored in local memory) of the source network storage system to a remote NVLog (e.g., stored in a remote memory) of a destination network storage system. An example of the use of NVLogs in the context of a clustered pair of physical network storage systems (or “filers”) is described in U.S. Pat. No. 7,493,424, which is hereby incorporated by reference for all purposes. When the network storage systems are implemented on virtual machine (VMs) in a public cloud, for example, rather than storing the NVLog in NVRAM and/or persisting the NVLog to disk, local VM memory may be used as a temporary storage and/or the NVLog may be additionally or alternatively persisted a cloud volume (e.g., Amazon Elastic Block Store (EBS) volume or the like).

As the NVLog mirroring is performed responsive to file system events, various actions associated with the mirroring process are typically tied to one or more storage operation phases performed by the file system. Depending on the file system in use, different operational phases may be flexible or inflexible. For example, in the context of WAFL, the load phase is flexible and includes the ability to be suspended; however, the modify phase is inflexible and cannot be preempted once started. In an HA environment, the NVLog mirroring operation has traditionally been performed during the modify phase using an RDMA operation. For example, just before performing the RDMA operation during the modify phase an output slot is obtained within a fixed-size send queue within the IC layer.

Due to the fixed-size of the send queue (which may also be referred to herein as an outbound IC queue), there may be times at which no slots are available. As this occurs during storage operation phases that are inflexible (e.g., the WAFL modify phase), the operation cannot be preempted, so the central processing unit (CPU) enters a wait loop until a slot is available. Notably, there are scenarios in which this wait loop may lock out all other processes, including those processes that might free up an output slot. At present, recovery from this type of a deadlock situation occurs when the wait loop reaches its time out threshold, terminates its execution, and declares the IC write operation at issue as a failure. At this point, an HA outage condition may exist as the mirror may be out of synchronization with the primary. Typical recovery from this type of HA outage involves tearing down the links between the primary network storage system and its HA and DR partners and resynchronizing and reestablishing the mirror.

While NVLog mirroring is one example in which file system operations may get ahead of the buffering provided by queues associated with RDMA transfers, it is to be appreciated other factors may contribute to and/or independently bring about a scarcity of slots in the send queue. For example, the geographical distance, the number or type of intermediate networking nodes between the storage systems at issue, and/or the implementation of the RDMA layer (e.g., hardware-based RDMA vs. software emulated RDMA) may result in network latency, losses, and/or delays. Therefore, the proposed reservation system is expected to be useful in connection with data transfers between storage nodes operating within cloud environments. That being said, the proposed reservation system may be useful in node-to-node data transfer scenarios in which (i) both the source and destination nodes reside in the cloud (e.g., a private cloud, public cloud or hyperscaler), (ii) one node resides in an on-premise environment and the other resides in the cloud, and (iii) both nodes reside in the same or different on-premise environment.

Embodiments described herein seek to address various of the foregoing issues by making the outbound IC queue capable of taking reservations and performing the reservation request during a file system phase (e.g., the WAFL load phase) that is capable of being suspended. When a reservation cannot be provided due to unavailability of a sufficient number of slots in the outbound IC queue for the transaction at issue, the file system task suspends until a reservation can be obtained. When the file system thread enters the modify phase, the reservation is used to consume the previously reserved slots in the outbound IC queue. In this manner, slots will be available in the modify phase and the existing deadlock situation should no longer arise.

As described further below, in one embodiment, the outbound IC queue may be partitioned into multiple portions, for example, a first portion (e.g., an urgent pool of slots and/or an available pool of slots) and a second portion (e.g., a no reservation pool of slots). Reservations may be made in the available pool and the urgent pool by aware IC clients (e.g., the WAFL file system) for a predetermined set of urgent operations (e.g., as defined by the needs of the file system). The no reservation pool may be used to handle existing client threads, for example, client-initiated file operations or input/output operations that utilize the IC queue in accordance with the current usage model (without making a reservation for slots in advance). In this manner, developer effort may be saved by avoiding updating of a number of existing clients, for example, that make use of the outbound IC queue, and which do not contribute significantly to the prior deadlock situation.

While some embodiments of the present disclosure are described herein with reference to particular usage scenarios in the context of a particular type of cross-site HA storage solution implementing the WAFL file system, it is to be noted that various embodiments of the present disclosure are equally applicable to other use cases that arise in the context of storage solutions more generally, including asynchronous DR solutions and those implementing other file systems having one or more non-suspendable phases similar to the WAFL modify phase. As such, the proposed reservation approach is equally applicable to other multi-phase file systems that rely on some form of communication channel (with transmission queues) to replicate journal entries to a partner (or neighbor) node or to the general transfer of data to a partner, neighbor, or any other node.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

### Example Operating Environment

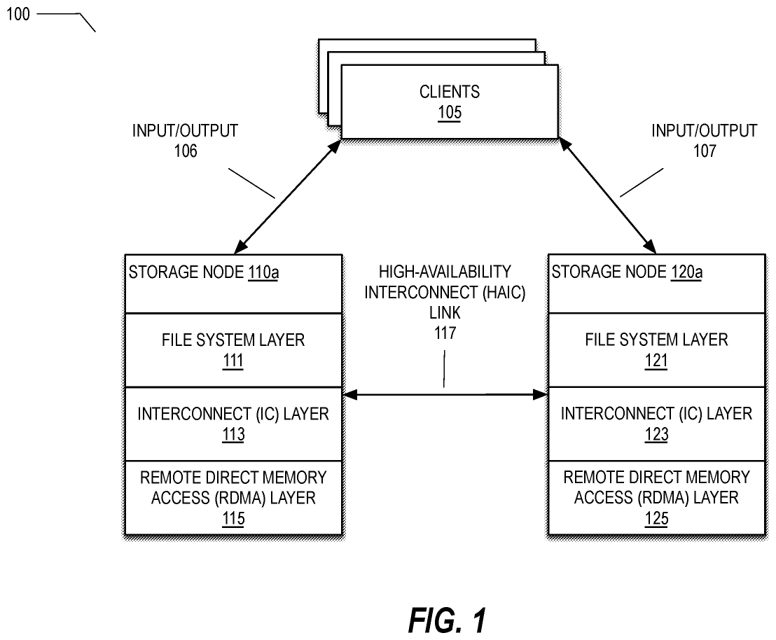

FIG. 1 is a block diagram illustrating an environment 100 in which various embodiments may be implemented. In various examples described herein, multiple storage nodes (e.g., storage nodes 110a and 120a) may be part of a storage solution providing high availability (HA) and/or disaster recovery (DR) in which the storage nodes reside in different fault domains (e.g., power and/or networking failure domains) and/or in different regions (e.g., geographically distributed data centers or public cloud provider availability zones). Depending upon the particular implementation, one or both of the storage nodes may be represented in physical or virtual form. Non-limiting examples of storage nodes in physical form include network storage systems or appliances that are capable of supporting one or both of Network Attached Storage (NAS) and Storage-Area Network (SAN) accessibility from a single storage pool, which may be referred to as Fabric Attached Storage (FAS). A virtual storage node may be implemented as a virtual machine (VM), containers, an/or pods within a private or public cloud (e.g., Amazon Web Services, Microsoft Azure, or Google Cloud Platform).

The storage nodes may represent special purpose nodes operable to provide file services relating to the organization of information on storage devices associated with the storage nodes. A non-limiting example of such special purpose node includes a “filer,” which may represent a high-performance all flash FAS (AFF) storage array scalable to terabytes of data that presents storage over the network using various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. The “filer” may be configured to operate according to a client/server model of information delivery to thereby allow many clients 105 to access files stored on a server, e.g., the filer. In this model, the client may comprise an application, such as a database application, executing on a computer that “connects” to the filer over a computer network, such as a point-to-point link, shared local area network (LAN), wide area network (WAN), or virtual private network (VPN) implemented over a public network, such as the Internet. The clients may request services of a storage node by issuing Input/Output requests 106 or 107 (e.g., file system protocol messages (in the form of packets) over the network).

The data served by the storage nodes may be distributed across multiple storage units embodied as persistent storage devices, such as hard disk drives (HDDs), solid state drives (SSDs), flash memory systems, or other storage devices. The storage nodes may logically organize the data stored on the devices as volumes accessible as logical units. Each volume may be implemented as a set of data structures, such as data blocks that store data for the volume and metadata blocks that describe the data of the volume.

In the context of the present example, storage node 110a is shown with a file system layer 111, an interconnect (IC) layer 113, and a Remote Direct Memory Access (RDMA) layer 115. File system layer 111 may be a multi-phase file system that performs multiple phases (e.g., load and modify) before data associated with a write operation is written to disk. For example, during the load phase for a write operation, file system data (e.g., Modes) may be loaded from disk into memory. Thereafter, lock (if applicable), modify, and resize (if applicable) phases may be performed in sequence. In one embodiment, the file system layer 111 is a “write in-place” file system (e.g., the Berkeley fast file system) or a write-anywhere file system (e.g., the Write Anywhere File Layout (WAFL) file system available from NetApp, Inc. of San Jose, Calif.).

The IC layer 113 provides an application programming interface (API) to upstream and downstream layers and abstracts the implementation of certain functionality performed on behalf of the file system layer 111. For example, the IC layer 113 may allow the storage node 110a to check whether an HA or DR partner is functioning and/or to mirror log data to and/or from the other's nonvolatile memory via a high-availability interconnect (HAIC) link 117. According to one embodiment, the IC layer 113 makes use of the RDMA layer 115 to encapsulate RDMA frames within Ethernet packets for transmission via the HAIC link 117 by communicating with the RDMA layer 115 via an RDMA driver.

The RDMA layer 115 and its counterpart (RDMA layer 125 of storage node 120a) may facilitate the exchange of data between storage nodes (potentially through intermediate network devices, such as switches, routers, and the like). The RDMA layer 115 may use RDMA technology to facilitate faster data transfer and low-latency networking. Like locally based Direct Memory Access (DMA), RDMA technology may improve throughput and performance because it frees up resources. The RDMA layers 115 and 125 may also be referred to herein individually as an RDMA provider. In one embodiment, the IC layer 113 accesses the RDMA layer 115 via a standard RDMA provider interface (e.g., OpenFabrics Enterprise Distribution (OFED) methods and a standard work request format).

Depending on the nature of the storage node at issue, the RDMA provider may represent hardware, software, or a combination thereof. For example, in the context of a physical storage system, the RDMA provider may facilitate the exchange of data in main memory via RDMA technology without involving the processor, cache or operating system of either storage node using a feature called zero-copy networking. In one embodiment, the RDMA provider enables more direct data movement in and out of the respective storage nodes 110a and 120a by implementing a transport protocol in the network interface card (NIC) hardware. In the context of a virtual storage system, the RDMA provider may implement a software emulation of RDMA, for example, on top of the User Datagram Protocol (UDP).

The functionality of file system layer 121, IC layer 123, and RDMA layer 125 of storage node 120a generally correspond to their respective counterparts in storage node 110a.

Depending upon the particular configuration, storage requests (e.g., Input/Output 106 and 107) may be directed to data stored on storage devices associated with one of the storage nodes. As described further below, certain types of storage requests may be logged (e.g., in the form of journal entries) to non-volatile random access memory (NVRAM) or local VM memory, as the case may be, and mirrored to the other storage node, which may represent an HA partner or a DR partner. Similarly, the data associated with the storage request may be synchronously, semi-synchronously, or asynchronously replicated to maintain consistency between datasets of the storage nodes to support continuous availability, for example, by failing over from one storage node to the other should one of the storage nodes become inaccessible to the clients 105 for some reason.

While in the context of the present example, only two storage nodes are shown, it is to be appreciated storage nodes 110a and/or 120a may be part of a cluster of local and/or remote storage nodes depending upon the particular configuration. As such, a storage node may have more than one HA or DR partner in the same or a different data center or public cloud availability zone.

While in the context of the present example, only one link (e.g., HAIC link 117) is shown for mirroring of log data. It is to be noted, due to differences in the level of importance of efficiency and timely completion of data transfers and/or depending upon the particular implementation, mirroring of log data to an HA partner and the mirroring of log data to a DR partner may use different links. For example, mirroring between or among HA partners may make use of the HAIC link 117, whereas mirroring to a DR partner may be via a different network link (not shown).

### Example Storage Node Layers

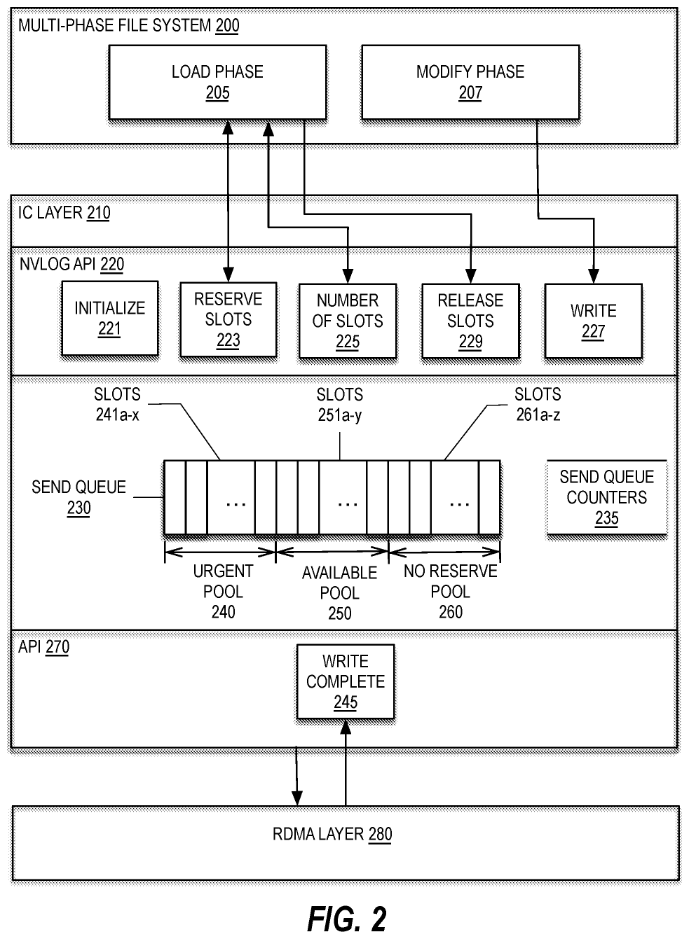

FIG. 2 is a simplified block diagram conceptually illustrating interactions among various layers of a storage node in accordance with an embodiment of the present disclosure. In the context of the present example, a storage node (e.g., storage node 110a or storage node 120a) includes a multi-phase file system layer 200 (e.g., WAFL), an IC layer 210, and an RDMA layer generally corresponding to the file system layer 111 and 121 of FIG. 1, the IC layers 113 and 123 of FIG. 1, and the RDMA layers 115 and 125 of FIG. 1, respectively.

For purposes of brevity, the file system 200 shows those interactions of significance to the issue at hand with the IC layer 210 during a load phase 205 and a modify phase 207 of a request. The request may be initiated by a message received from a file system client (e.g., one of clients 105 of FIG. 1) or may be as a result of internal file system processing.

The IC layer 210 exposes an NVLOG API 220 for use by IC clients (e.g., the file system 200) and an API 270 for use by the RDMA layer 280. Those skilled in the art will appreciate the IC layer 210 includes other APIs and functional units that are outside of the scope of the present discussion. The NVLOG API 220 is operable to initialize a send queue 230, make and release reservations of slots within the send queue 230 and consume the reserved slots within the send queue 230. In one embodiment, IC clients making use of the reservation system implemented by the NVLOG API 220 follow a reserve, consume, release design pattern for IC resources (e.g., slots within send queue 230).

While in the context of the present example, only a single send queue is depicted, it is to be appreciated there may be multiple send queues. For example, each send queue may represent a send queue associated with a queue pair (QP) (a pair of send and receive queues) of multiple QPs maintained within the RDMA layer 115 corresponding to a given cluster partner and for exchanging data with the given cluster partner. Those skilled in the art will appreciate some QPs may represent “loopback” QPs to implement local DMA (LDMA) within the source storage node.

In the context of the present example, the NVLOG API 220 includes an initialize method 221, a reserve slots method 223, a number of slots method 225, a release slots method 229, and a write method 227. The initialize method 221 may be used by the WAFL file system 220 to initialize multiple pools of slots (e.g., an urgent pool 240, an available pool 250, and a no reserve pool 260) within the send queue 230. For example, of a fixed number of slots supported by the send queue 230, slots 241a-x may be established for use by the urgent pool 240, slots 251a-y may be associated with the available pool 250, and slots 261a-z may be assigned to the no reserve pool 260. According to one embodiment, the respective sizes of the pools may be based at least in part on the number of MP processors in the system and the bandwidth of the link (e.g., the HAIC link 117) interconnecting the source and destination storage nodes.

The reserve slots method 223 may be used by the multi-phase file system 200 during the load phase 205 of a request (e.g., a write request) to reserve a specified number of slots for use during the subsequent modify phase 207. According to one embodiment, a Source Address, a Destination Address, and a size of the data transfer are provided when the write request is received by the IC layer. The write request is expected to take the number of reservations' send queue slots (entries) previously calculated (e.g., by the number of slots method 225). Requests may then be broken down into properly formed work requests per send queue entry (slots) and given to the RDMA provider (along with a transfer ID generated for tracking purposes) using, for example, OFED methods and a standard work request format. The last send queue entry transfer ID may be provided to the IC client as the overall transaction ID and may be used to determine when the write is complete.

According to one embodiment, reservations with an urgent flag or parameter set (urgent reservations) may be made within the urgent pool 240 or the available pool 250 (e.g., when urgent slots are unavailable), whereas reservations without the urgent flag set may be made within the available pool 250. In some examples, urgent reservations may be limited for use by certain low latency and low volume urgent messages (e.g., internal WAFL operations that are vital to maintain filer functionality). In the context of a distributed storage system made up of a cluster of storage nodes, a non-limiting example of an urgent message is a volume move message that may update a database storing the location of volumes (e.g., which nodes host which volumes) within the distributed storage system. Other non-limiting examples of file system operations that may generate urgent messages include Quality of Service (QoS) policy creation/modification/deletion, NFS locking operations, operations relating to create and/or management of data protection mirrors, extended data protection relationships, or load-sharing mirrors, Volume Creates/Modify/Deletes, and Quota Add/Modify/Delete.

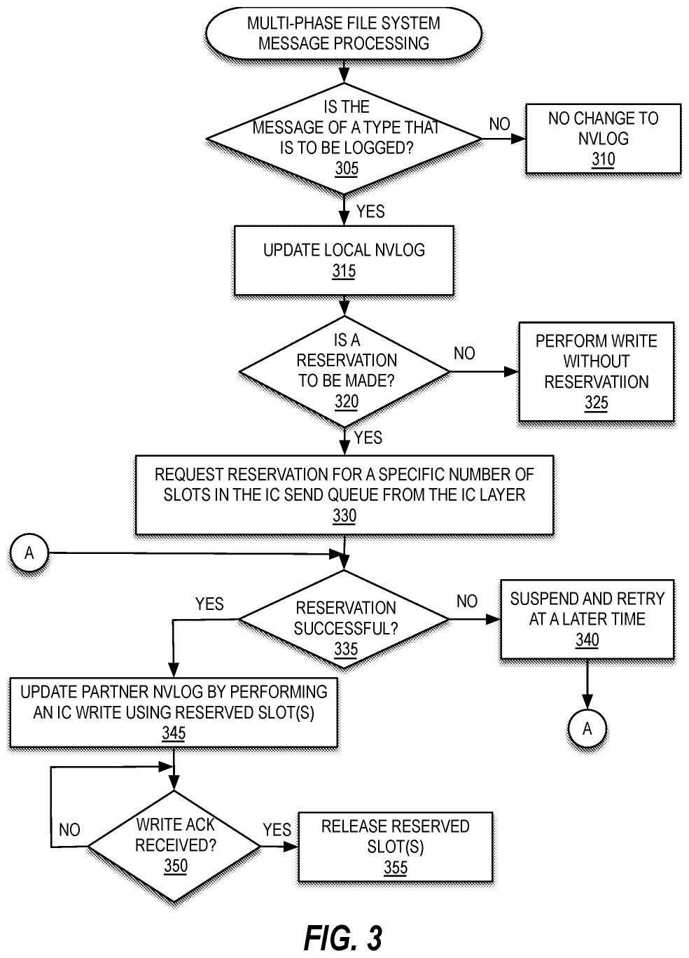

Responsive to receipt of a reservation via the reserve slots method 223, the IC layer may determine whether it can satisfy the request for the specified number of slots. If so, the IC layer may update appropriate counters (e.g., reduce a count of available slots for reservation and/or increase a count of reserved slots no longer available for reservation with the pool at issue) to reflect the unavailability of the reserved slots until they have been released and return success status code to the calling thread, which may then proceed to the modify phase 207. These counters may be again modified when slots are explicitly released by a thread and/or responsive to completion of the RDMA operation at issue. When insufficient slots are available, the IC layer may return an error status code and the file system thread may suspend until a reservation can be obtained as described further below with reference to FIG. 3.

The number of slots method 225 may be used by IC clients to determine the number of slots required for a particular operation. For example, various IC RDMA providers may have different capabilities that make it difficult for the calling thread to determine in advance for all cases the number of slots needed. For such operations, the IC client may provide information regarding the transfer source and size to allow the IC layer to calculate and return the number of slots for the operation at issue, for example, based on the IC layer RDMA provider's capabilities, including, but not limited to, a maximum slot transfer byte allowance, a maximum scatter/gather entry size and a count per slot, and/or other limitations of the RDMA provider—as well as the local physical contiguity of the data to transfer. With the number of slots (e.g., calculated by the IC layer based on characteristics of the RDMA provider) now in hand, the thread may proceed to attempt to make the reservation for the number of slots via the reserve slots method 223.

The release slots method 229 may be used by IC clients to return slots if they are unable to be consumed (e.g., the load phase 205 is suspended) or upon completion of the RDMA transfer. In one embodiment, reservations (of potentially many slots) are used as write requests are submitted against the reservations (e.g., during the modify phase). Another reservation is not available for reserved slots until the RDMA provider completes the work request and the completion polled by the IC layer, for example. An RDMA completion queue may be updated by the provider when the send queue entry data has been confirmed to have been placed in remote memory. When a new completion queue entry is polled by the IC layer this can be used as a trigger to free up the send queue entry (slot). If reservations are released without use, that number of slots is available for reservation at release. In alternative embodiments, slots may be released in a prioritized order. For example, when a completion free a used slot, it may first be made available to the urgent pool, for example, if the number of available urgent slots is below a predetermined threshold; otherwise, it may go to the no reservation pool, and lastly to the available pool.

The API 270 includes a write completion method 245 through which the RDMA layer 280 may signal completion of a particular operation. This completion may be propagated up the layers to facilitate release of the reserved slots by the IC client or the write complete method 245 may perform the release of reserved slots.

While a limited set of API methods are described above with reference to the NVLOG API 220, more or fewer API methods may be exposed as appropriate for the particular implementation. For example, the burstiness of certain code paths in the multi-phase file system 200 in which there might be a large number of transfers in a relatively short timeframe may be accommodated by providing a method by the NVLOG API 220 to allow the multi-phase file system 200 to check the fullness level of the reserve pools (e.g., the urgent pool 240 or the available pool 250, individually or collectively).

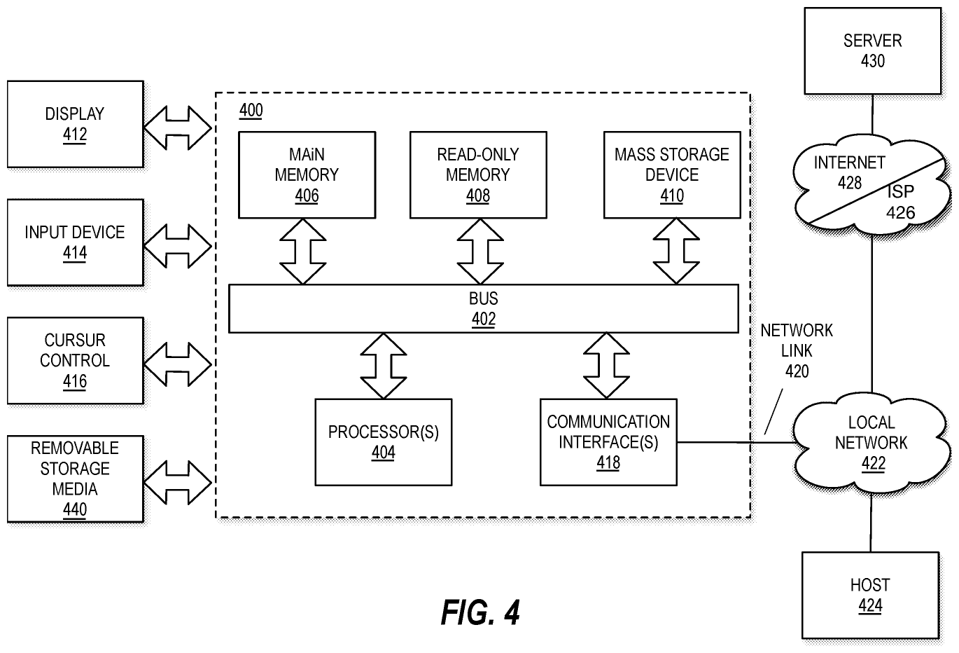

The various layers described herein, and the processing described below with reference to the flow diagram of FIG. 3 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms (e.g., servers, blades, network storage systems or appliances, and storage arrays, such as the computer system described with reference to FIG. 4 below.

### Example File System Message Processing

FIG. 3 is a flow diagram illustrating multi-phase file system message processing in accordance with an embodiment of the present disclosure. At decision block 305, the file system (e.g., file system layer 111 or 121 or multi-phase file system 200) determines whether the message at issue is of a type that is to be logged. If so, processing continues with block 315 where the local NVLog is updated; otherwise, processing branches to block 310 where no changes are made to the local NVLog. According to one embodiment, the determination regarding whether the message at issue is of a type that is to be logged is based on whether the message is of a type that modifies data. For example, entries may be added to the local NVLog (and mirrored to the remote NVLog of a cluster partner) by the source storage node for those messages relating to storage requests that modify data (e.g., write requests) that are served by the source storage node since the last consistency point. As such, read requests and the like, that do not modify data need not be logged.

At block 310, no changes are made to the local NVLog and multi-phase file system message processing is complete (from the perspective of local logging and NVLog mirroring).

At block 315, the local NVLog is updated to include a new entry containing information regarding the storage request. For example, the new entry may include a sequence number (e.g., for tracking inflight operations), the operation, and optionally the data associated with the operation.

At decision block 320, a determination is made regarding whether a load-phase reservation of slots is to be made for the operation at issue during the load phase (e.g., load phase 205). For example, the file system may make reservations for a predetermined or configurable set of operations. In some implementations, reservations with an urgent flag or parameter set (urgent reservations) may be made within an urgent pool (e.g., urgent pool 240) or an available pool (e.g., available pool 250), for example, when urgent slots are unavailable, whereas reservations without the urgent flag set may be made within the available pool. Urgent reservations may be limited for use by certain low latency and low volume urgent messages (e.g., a predetermined set of vital internal file system operations).

If a determination is to make a load-phase reservation of slots for the operation at issue during the load phase, processing continues with block 330; otherwise, processing branches to block 325. In general, load-phase reservations may be made for a specified number of slots within the send queue (e.g., send queue 230) in the urgent pool or the available pool for client operations (e.g., write, create, remove, link, and the like that result in a change in the file system. According to one embodiment, the IC layer (e.g., IC layer 210) provides an API method (e.g., the reserve slots method 223) through which IC clients may obtain a load-phase reservation for a specified number of slots for an operation that will be performed during the subsequent modify phase (e.g., modify phase 207). The number of slots may be specified via a parameter of the API method.

At block 325, a load-phase reservation of slots has not been performed and the operation proceeds with the prior approach of reserving slots during the modify phase immediately preceding the IC write (e.g., write method 227). As noted above, such an approach does not guarantee the availability of the needed slots and may involve the thread performing a wait loop until sufficient slots become available. According to one embodiment, these modify-phase reservations are limited by slots available within the no reserve pool 260.

At block 330, the thread requests a load-phase reservation within the send queue for a specified number of slots. For example, the thread may invoke a reserve API method (e.g., the reserve slots method 223). In one embodiment, the reserve API method includes an urgent parameter or flag through which the caller may identify the request as an urgent one that is to receive preferential treatment. If the number of slots for the operation at issue is not ascertainable by the thread, as described above, the thread may make use of an API method (e.g., the number of slots method 225) to have the IC layer calculate and return the number of slots and may then proceed with the reservation request.

At decision block 335, a determination is made regarding whether the load-phase reservation was successful. If so, processing continues with block 345; otherwise, processing branches to block 340. In one embodiment, the calling thread may determine the status of the load-phase reservation via a status code (e.g., success, not available, link down, error) returned by the reserve slots method.

At block 340, the load-phase reservation was not successful. As such, the thread suspends and retries the load-phase reservation at another time. There are a variety of mechanisms that may be used to implement the retry. In one embodiment, the calling thread may register a call back routine with the IC layer that is to be called by the IC layer when sufficient slots are available for the operation at issue. Alternatively, the file system (e.g., WAFL) may actively probe the IC layer and retry the reservation as slots become available.

At block 345, the cluster partner's remote NVLog may be updated by performing an IC write using the slots previously reserved during the load phase of the operation. In one embodiment, the IC layer exposes an API method (e.g., write method 227) that may be invoked by the thread at issue and the slots will be available for use by virtue of the prior explicit reservation.

At decision block 350, it is determined whether a write acknowledgement (or other indication of completion) has been received for the RDMA operation (e.g., via the write complete method 245). If so, then processing continues with block 355 at which the WAFL file system releases the reserved slots, for example, by calling the release slots method 229; otherwise, the release of slots is triggered upon receipt of the indication of completion.

While in the context of the present example, a number of enumerated blocks are included, it is to be understood that examples may include additional blocks before, after, and/or in between the enumerated blocks. Similarly, in some examples, one or more of the enumerated blocks may be omitted and/or performed in a different order.

### Example Computer System

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 4 is a block diagram that illustrates a computer system 400 in which or with which an embodiment of the present disclosure may be implemented. Computer system 400 may be representative of all or a portion of the computing resources associated with a network storage system (e.g., storage node 110a or 120b). Notably, components of computer system 400 described herein are meant only to exemplify various possibilities. In no way should example computer system 400 limit the scope of the present disclosure. In the context of the present example, computer system 400 includes a bus 402 or other communication mechanism for communicating information, and a processing resource (e.g., a hardware processor 404) coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, e.g., a magnetic disk, optical disk or flash disk (made of flash memory chips), is provided and coupled to bus 402 for storing information and instructions.

Computer system 400 may be coupled via bus 402 to a display 412, e.g., a cathode ray tube (CRT), Liquid Crystal Display (LCD), Organic Light-Emitting Diode Display (OLED), Digital Light Processing Display (DLP) or the like, for displaying information to a computer user. An input device 414, including alphanumeric and other keys, is coupled to bus 402 for communicating information and command selections to processor 404. Another type of user input device is cursor control 416, such as a mouse, a trackball, a trackpad, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Removable storage media 440 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 400 may implement the techniques described herein using customized hard-wired logic, one or more ASICs or FPGAs, firmware or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 410. Volatile media includes dynamic memory, such as main memory 406. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, or stored in storage device 410, or other non-volatile storage for later execution.

What is claimed is:

1. A storage system comprising:
one or more processing resources; and
one or more non-transitory computer-readable media, coupled to the one or more processing resources, having stored therein instructions that when executed by the one or more processing resources cause the storage system to:
maintain a send queue having a fixed number of slots within an interconnect layer of the storage system interposed between a file system and a Remote Direct Memory Access (RDMA) layer of the storage system;
during a first phase of a plurality of phases of a write transaction of the file system, facilitate a transfer of data from the storage system to another storage system by making a reservation for a plurality of slots within the send queue; and
during a second phase of the plurality of phases of the write transaction, consume the reservation and cause the interconnect layer to perform an RDMA operation to carry out the transfer of data.

2. The storage system of claim 1, wherein the instructions further cause the storage system to maintain a log file containing a plurality of storage operations performed on the storage system since completion of a consistency point, and wherein the data represents at least a portion of the log file.

3. The storage system of claim 1, wherein the fixed number of slots is partitioned into an urgent pool, an available pool, and a no reserve pool, and wherein the reservation is made within the urgent pool or the available pool.

4. The storage system of claim 3, wherein the instructions further cause the storage system to initialize a number of slots of the fixed number of slots for each of the urgent pool, the available pool, and the no reserve pool.

5. The storage system of claim 1, wherein the RDMA layer is software emulated.

6. The storage system of claim 1, wherein the first phase comprises a suspendable phase and the second phase comprises a non-preemptable phase.

7. The storage system of claim 1, wherein the interconnect layer implements an application programming interface (API) exposing a method through which a client of the interconnect layer receives information regarding a number of slots of the fixed number of slots required for performing a given transaction.

8. The storage system of claim 1, wherein the send queue is mapped to a particular queue pair (QP) of a plurality of QPs maintained within the RDMA layer.

9. A method performed by one or more processing resources of a network storage system, the method comprising:
maintaining, by an interconnect layer of the network storage system interposed between a file system and a Remote Direct Memory Access (RDMA) layer of the network storage system, a send queue having a fixed number of slots;
during a load phase of a write transaction of the file system, making, by the file system, a reservation for a plurality of slots within the send queue to facilitate a transfer of a portion of a log file from the network storage system to a secondary network storage system by invoking a first method of an application programming interface (API) of the interconnect layer; and
during a modify phase of the write transaction, consuming, by the file system, the reservation and causing the interconnect layer to perform an RDMA operation to carry out the transfer.

10. The method of claim 9, wherein the fixed number of slots is partitioned into an urgent pool, an available pool, and a no reserve pool, and wherein the reservation is made within the urgent pool or the available pool.

11. The method of claim 9, further comprising initializing, by the file system, a number of slots of the fixed number of slots for each of the urgent pool, the available pool, and the no reserve pool via an initialize method of the API.

12. The method of claim 9, wherein the file system comprises a write-anywhere file system.

13. The method of claim 9, further comprising responsive to receipt by the file system of an acknowledgement indicative of completion of the RDMA operation, releasing, by the file system, the reservation.

14. The method of claim 9, wherein the API exposes a second method through which a client of the interconnect layer receives information regarding a number of slots of the fixed number of slots for performing a given transaction.

15. The method of claim 9, wherein the send queue is mapped to a particular queue pair (QP) of a plurality of QPs maintained within the RDMA layer.

16. A non-transitory computer-readable storage medium embodying a set of instructions, which when executed by one or more processing resources of a network storage system, cause the network storage system to:
maintain a send queue having a fixed number of slots within an interconnect layer of the network storage system interposed between a file system and a Remote Direct Memory Access (RDMA) layer of the network storage system;
during a first phase of a multi-phase transaction of the file system, facilitate a transfer of data from the network storage system to another network storage system by making a reservation for a plurality of slots within the send queue; and
during a second phase of the multi-phase transaction, consume the reservation and cause the interconnect layer to perform an RDMA operation to carry out the transfer of data.

17. The non-transitory computer-readable storage medium of claim 16, wherein the instructions further cause the network storage system to maintain a log file containing a plurality of storage operations performed on the network storage system since completion of a consistency point, and wherein the data represents at least a portion of the log file.

18. The non-transitory computer-readable storage medium of claim 16, wherein the RDMA layer is software emulated.

19. The non-transitory computer-readable storage medium of claim 16, wherein the interconnect layer implements an application programming interface (API) exposing a method through which a client of the interconnect layer receives information regarding a number of slots of the fixed number of slots required for performing a given transaction.

20. The non-transitory computer-readable storage medium of claim 16, wherein the send queue is mapped to a particular queue pair (QP) of a plurality of QPs maintained within the RDMA layer.
